(19) United States
(12) Patent Application Publication
(10) Pub. No.: US 2005/0051259 A1
(43) Pub. Date: Mar. 10, 2005

(54) Method for sealing heat pipes

(76) Inventor: Chin-Kuang Luo, Taichung City (TW)

Correspondence Address: TROP PRUNER & HU, PC, 8554 KATY FREEWAY, SUITE 100, HOUSTON, TX, 77024, US

(21) Appl. No.: 10/900,603

(22) Filed: Jul. 28, 2004

(30) Foreign Application Priority Data
Sep. 9, 2003 (TW) 092124886

(51) Int. Cl. B29C 57/10; B29C 65/16

(52) U.S. Cl. 156/198; 156/251

(57) ABSTRACT

A method for sealing an open end of a heat pipe includes the steps of pressing the open end of the heat pipe to form a closed end by using a pressing jig, and projecting a laser beam onto the closed end so as to simultaneously cut and weld the closed end, thereby sealing the closed end of the heat pipe.

### CROSS-REFERENCE TO RELATED APPLICATION

This application claims priority of Taiwanese Application No. 092124886, filed on Sep. 09, 2003.

### BACKGROUND OF THE INVENTION

1. Field of the Invention

The invention relates to a heat pipe, more particularly to a method for sealing a heat pipe.

2. Description of the Related Art

Referring to FIGS. 1 to 4, a conventional method for producing a heat pipe 10 includes the steps of providing a metallic hollow body 11 with an open end portion 111 and an inner chamber, pouring a suitable amount of heat transfer liquid (not shown) into the hollow body 11, and evacuating and sealing the hollow body 11. The conventional method for sealing the heat pipe 10 includes the following steps:

(A) Pressing the open end portion 111 of the hollow body 11 by using a pressing jig 2 so as to close the open end portion 111 and so as to form a flattened end portion 112;

(B) Cutting a top end part 1121 of the flattened end portion 112 by means of a cutting machine 3; and

(C) Sealing the heat pipe 10 by using a spot welding device. A welding spot, represented by numeral 12, is shown in FIG. 4.

Although the conventional method for sealing the heat pipe 10 achieves its intended purpose using the aforesaid three steps, there is a need to provide a more simplified step in sealing the open end portion 111 of the heat pipe 10 so as to minimize working time and sealing cost.

### SUMMARY OF THE INVENTION

Therefore, the object of the present invention is to provide a method for sealing an open end of a heat pipe via a simple operating procedure so as to minimize costs.

According to this invention, a method for sealing an open end of a heat pipe 100 comprises the steps of: (A) pressing the open end of the heat pipe 100 to form a closed end 22 by using a pressing jig; and (B) projecting a laser beam onto the closed end 22 so as to simultaneously cut and weld the closed end 22, thereby sealing the closed end 22 of the heat pipe 100.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary sectional view of a conventional heat pipe prior to pressing an open end portion thereof by means of a pressing jig;

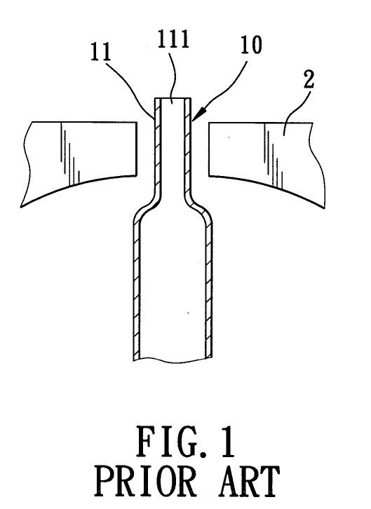

FIG. 2 is another fragmentary sectional view of the conventional heat pipe, illustrating the pressing of the open end portion of the heat pipe by the pressing jig to form a flattened end portion;

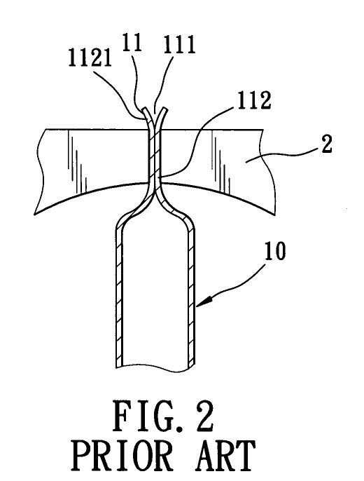

FIG. 3 is yet another fragmentary sectional view of the conventional heat pipe, illustrating a top end part of the flattened end portion which has been cut by a cutting machine;

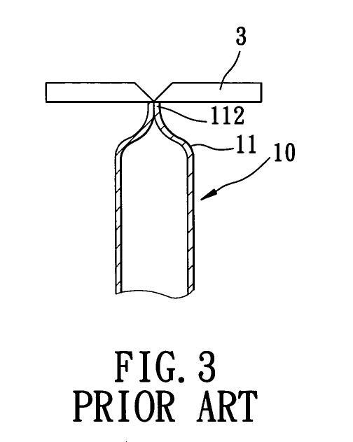

FIG. 4 is a further fragmentary sectional view of the conventional heat pipe, illustrating that the heat pipe has been sealed by spot welding;

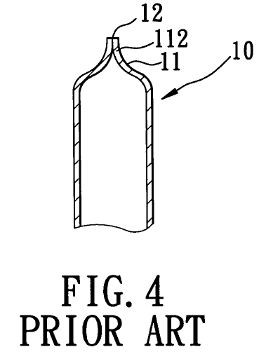

FIG. 5 is a flow chart illustrating a method for sealing an open end of a heat pipe according to the present invention;

FIG. 6 is a fragmentary perspective view of the heat pipe, with the open end being pressed to form a flattened end part;

FIG. 7 is the same view as FIG. 6, showing the flattened end part after being bent; and

FIG. 8 is the same view as FIG. 6, showing the flattened end part after being twisted.

### DETAILED DESCRIPTION OF THE PREFERRED EMBODIMENTS

Before the present invention is described in greater detail, it should be noted that like elements are denoted by the same reference numerals throughout the disclosure.

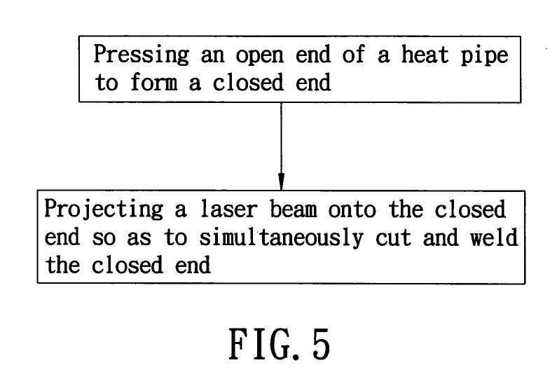

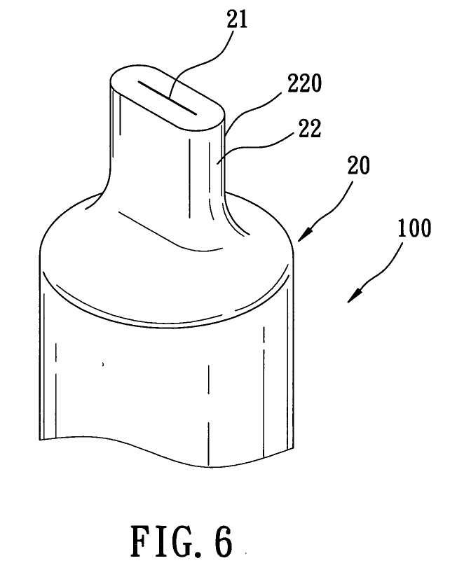

Referring to FIGS. 5 and 6, a method for sealing a heat pipe 100 according to the present invention is adapted to be applied to a hollow body 20 having an open end (not shown). After the hollow body 20 is filled with a heat transfer fluid (not shown), it is evacuated. Since the filling and evacuating processes of the hollow body 20 of the heat pipe 100 are substantially similar to those of the conventional heat pipe 10, and since these processes are not pertinent to the present invention, a detailed description of the same will be dispensed herewith for the sake of brevity.

The method for sealing the heat pipe 100 comprises the steps 30 and 40 shown in FIG. 5.

In step 30, after the hollow body 20 underwent the filling and evacuating processes, the open end of the hollow body 20 is pressed to form a closed end 22 by a pressing jig (not shown) so as to produce a flattened end part 220 (see FIG. 6).

In step 40, a laser beam of a laser device (not shown) is projected onto an upper end 21 (see FIG. 6) of the flattened end part 220 to simultaneously cut and weld the upper end 21, thereby sealing the closed end 22 of the hollow body 20 of the heat pipe 100.

It is noted that the conventional method for sealing the heat pipe 10 includes three steps that require three different kinds of processing devices, namely: pressing the open end portion 111 of the hollow body 11 by using the pressing jig 2 so as to form the flattened end portion 112; cutting the top end part 1121 of the flattened end portion 112 by using the cutting machine 3; and sealing the heat pipe 10 by using the spot welding device. The conventional method using these different processing devices to carry out the aforesaid steps is not only complicated, but is also time consuming.

Unlike the aforesaid conventional method for sealing the heat pipe 10, the method of the present invention utilizes two steps and two processing devices only, namely: pressing the open end (not shown) of the hollow body 20 to form the closed end 22 by using the pressing jig (not shown) so as to produce the flattened end part 220; and, projecting the laser beam of the laser device (not shown) onto the upper end 21 of the flattened end part 220 so as to simultaneously cut and weld the upper end 21, thereby sealing the closed end 22 of the heat pipe 100. Thus, the method for sealing the heat pipe 100 according to the present invention is simple and easy so that the working time can be saved and the sealing costs can be minimized.

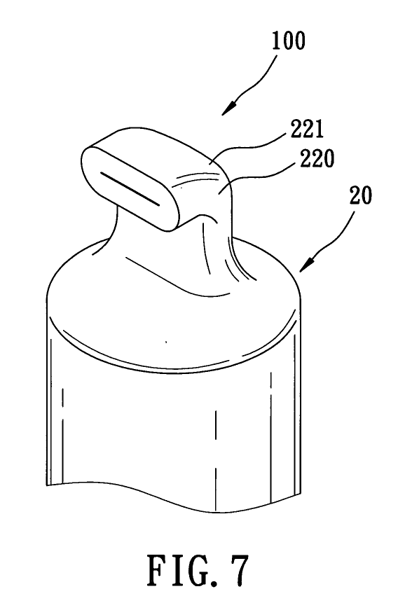

Referring to FIG. 7, the method for sealing the heat pipe 100 according to the present invention may further comprise the step of bending the flattened end part 220 of the hollow body 20 prior to cutting and welding the flattened end part 220 so as to form the heat pipe 100 with a bent end 221.

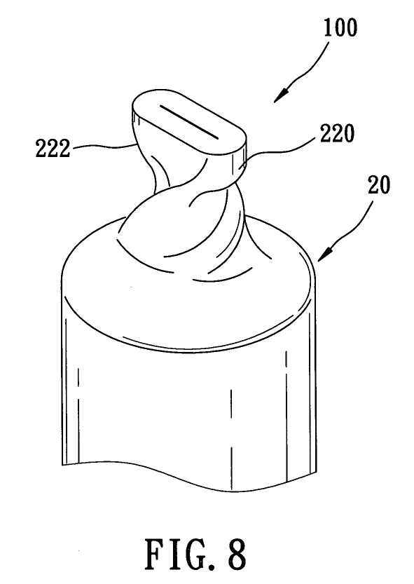

Alternatively, the method for sealing the heat pipe 100 according to the present invention may further comprise the step of twisting the flattened end part 220 of the hollow body 20 by using a self-rotating pressing jig (not shown) prior to cutting and welding the flattened end part 220 so as to form the heat pipe 100 with a twisted end 222, as shown in FIG. 8.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A method for sealing an open end of a heat pipe, said method comprising:
(A) pressing said open end of said heat pipe to form a closed end by using a pressing jig; and
(B) projecting a laser beam onto said closed end so as to simultaneously cut and weld said closed end, thereby sealing said closed end of said heat pipe.

2. The method as claimed in claim 1, wherein in step (A), said open end of said heat pipe is pressed to form a flattened end part.

3. The method as claimed in claim 2, further comprising bending said flattened end part before step (B).

4. The method as claimed in claim 2, further comprising twisting said flattened end part before step (B).
